(19) United States
(12) Patent Application Publication
(10) Pub. No.: US 2020/0308375 A1
(43) Pub. Date: Oct. 1, 2020

(54) LIQUID GUAYULE NATURAL RUBBER AS A PROCESSING AID

(71) Applicant: Ford Motor Company, Dearborn, MI (US)

(72) Inventors: Janice Lisa Tardiff, Plymouth, MI (US); Cindy Sofia Barrera-Martinez, Dearborn, MI (US); Katrina Cornish, Wooster, OH (US); Xianjie Ren, Wooster, OH (US)

(73) Assignee: Ford Motor Company, Dearborn, MI (US)

(21) Appl. No.: 16/367,987

(22) Filed: Mar. 28, 2019

(51) Int. Cl. C08L 9/06; C08L 7/00; C08K 5/00; C08K 3/04

(52) U.S. Cl. CPC C08L 9/06; C08L 7/00; C08C 1/075; C08K 3/04; C08K 5/0016

(57) ABSTRACT

A rubber composite comprises at least one of a natural and a synthetic rubber polymer and a plasticizer comprising a liquid natural rubber. The liquid natural rubber may be liquid guayule natural rubber. The rubber composite is substantially free of petroleum crude oil. Also provided are methods of making a rubber composite material including liquefying at least one of a guayule solid natural rubber and a guayule latex to form a liquid guayule natural rubber, mixing the liquid guayule natural rubber with at least one of a natural and a synthetic rubber polymer to form a rubber mixture, and vulcanizing the rubber mixture.

### FIELD

The present disclosure relates to a rubber composite material and products composed of the rubber composite material.

### BACKGROUND

The statements in this section merely provide background information related to the present disclosure and may not constitute prior art.

Rubbers parts and/or rubber materials can be formed by mixing together solid rubber polymers with one another and allowing the mixture to set. Care must be taken to ensure the mixture is adequately mixed, otherwise, the mixture may not set properly. Without processing aids, the expenditure of energy to adequately mix the rubber polymers with one another is prohibitively expensive in commercial applications and the rubbers may not properly mix.

Plasticizers are one common form of mixing aid that assist in the processability of rubber mixtures, thereby lowering the expenditure of energy necessary to mix rubber mixtures adequately to form rubbers with desired properties. Conventional plasticizers used in rubber mixtures include petroleum oils such as naphthenic oil, and esters such as phthalates, sebacates, and adipates. The composition of the rubber polymer mixture may dictate the selection of the plasticizer.

### SUMMARY

According to an aspect, a rubber composite includes a rubber polymer having at least one of a natural and a synthetic rubber polymer and a guayule natural rubber plasticizer added as a liquid during processing.

In a variation, the rubber composite material is substantially free of petroleum crude oil.

In a variation, the rubber composite further includes an additive. In other such variations, the additive is carbon black.

In a variation, the rubber composite material forms at least a portion of a bushing for a vehicle.

In a variation, the rubber polymer comprises a natural rubber polymer.

In a variation, the rubber polymer comprises a styrene-butadiene rubber polymer.

According to another aspect, a rubber composite material includes a rubber polymer having at least one of a natural and a synthetic rubber polymer and a guayule natural rubber or a hevea natural rubber plasticizer added as a liquid during processing. The rubber composite material is substantially free of petroleum crude oil.

In a variation, the plasticizer is liquid guayule natural rubber.

In a variation, the rubber composite material further includes an additive. In other such variations, the additive is carbon black.

In a variation, the rubber composite material forms at least a portion of a bushing for a vehicle.

In a variation, the rubber polymer comprises a natural rubber polymer.

In a variation, the rubber polymer comprises a styrene-butadiene rubber polymer.

According to another aspect, a method of making a rubber composite material includes liquefying at least one of a guayule solid natural rubber and a guayule latex to form a liquid guayule natural rubber. The liquid guayule natural rubber is mixed with at least one of a natural and a synthetic rubber polymer to form a rubber mixture, and the rubber mixture is vulcanized.

In a variation, the mixing includes mixing an additive. In other such variations, the additive is carbon black.

In a variation, the rubber mixture is formed into at least a portion of a bushing.

In a variation, at least one of a natural and a synthetic rubber polymer is a natural rubber polymer.

In a variation, at least one of a natural and a synthetic rubber polymer is a styrene-butadiene rubber polymer.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a graph illustrating the tear resistance of examples according to the present disclosure and comparative examples;

FIG. 1B is a graph illustrating the crosslink density of examples according to the present disclosure and comparative examples;

FIG. 1C is a graph illustrating the gel fraction of examples according to the present disclosure and comparative examples;

FIG. 2A is a graph illustrating the static stiffness of examples according to the present disclosure and comparative examples;

FIG. 2B is a graph illustrating the static stiffness of examples according to the present disclosure and comparative examples; and

FIG. 2C is a graph illustrating the dynamic stiffness of examples according to the present disclosure and comparative examples.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to an aspect of the present disclosure, liquid guayule natural rubber is used as a plasticizer in a rubber composite. Guayule is a woody plant that can have extracted therefrom useful products such as natural rubber and latex. Guayule natural rubber can be extracted according to known methods, which includes cultivating guayule, harvesting it, milling or grinding the harvested guayule, extracting the rubber by solvent, removing impurities, and removing the solvent. Extracting latex from guayule involves homogenizing a cultivated guayule plant. Guayule rubber is found primarily in the bark that must be released via processing. According to one method, branches are ground to form a slush by gently breaking open the cells in the plant, releasing intact rubber particles and creating an aqueous suspension. The aqueous suspension is separated, e.g., by a centrifuge. The guayule rubber particles are lighter than the aqueous solution and accordingly can be skimmed from the top of the aqueous solution.

Producing liquid guayule natural rubber from solid guayule rubber involves a multi-day process where solid guayule rubber is placed in an oven at a temperature held at about 80° C. for about fourteen days. The temperature of the oven is then increased to about 120° C. and held at about 120° C. for about an additional four days. Alternatively, solid guayule natural rubber may be melted to liquid guayule natural rubber by exposing the solid guayule natural rubber to ultraviolet light for a period of time sufficient to melt the solid guayule natural rubber. In yet another variation, solid guayule natural rubber may be melted to liquid guayule natural rubber via chemical degradation, such as by immersing the solid guayule natural rubber in an acid bath (e.g., periodic acid) for a period of time sufficient to degrade the solid guayule natural rubber.

Producing liquid guayule natural rubber from guayule latex involves a multi-day process where guayule latex is placed in an oven at a temperature held at about 125° C. for about eight days. Alternatively, guayule latex may be changed into liquid guayule natural rubber by exposing the guayule latex to ultraviolet light for a period of time sufficient to melt the guayule latex. In yet another variation, guayule latex may be changed into liquid guayule natural rubber via chemical degradation, such as by adding an amount of acid (e.g., periodic acid) sufficient to liquefy the guayule latex.

It is believed melting the guayule rubber into liquid guayule natural rubber breaks longer guayule rubber polymer chains into smaller guayule rubber polymer chains, thereby enhancing miscibility with the synthetic or natural rubber polymers forming the resultant rubber composite contemplated herein. By way of non-limiting example, solid guayule natural latex has a molecular weight of about 9.6×10\hat{ }5 g/mol, and the liquid guayule natural rubber may have a molecular weight of about 8.1×10\hat{ }4 g/mol. While not wishing to be bound to theory, it is believed reducing the molecular weight of the guayule rubber, the viscosity is reduced, allowing liquid guayule natural rubber to act as a processing aid. As such, it is contemplated that the above-mentioned processes for producing liquid guayule natural rubber from solid guayule rubber or guayule latex are exemplary in nature and other processes that adequately produce liquid guayule natural rubber are within the scope of the present disclosure.

The liquid guayule natural rubber is used as a plasticizer with a mixture of rubber polymers.

Examples of the mixture of rubber polymers include mixtures of synthetic rubber, mixtures of natural rubber, mixtures of various synthetic rubbers, mixtures of various natural rubbers, and mixtures of synthetic and natural rubbers. Examples of synthetic rubbers include but are not limited to styrene-buta-diene rubber (SBR), styrene-isoprene rubber (SIR), styrene-isoprene-butadiene rubber (SIBR), isoprene rubber (IR), chlorosulphonated polyethylene rubber (CSM), epichlorohydrin rubber (ECO), fluoroelestomers, fluorocarbons, fluorosilicone rubber, hydrogenated nitrile rubber (HNBR), acrylonitrile butadiene rubber, perfluoroelastomers (FFKM), polyacrylic rubber (ACM), butadiene rubber (BR), ethylene-propylene-diene rubber (EPDM), chloroprene rubber (CR), acrylonitrile-butadiene rubber (NBR), and butyl rubber (IIR). According to an example, the rubber polymer mixture comprises SBR. Examples of natural rubber include guayule natural rubber (GNR), and hevea natural rubber (HNR).

Liquid guayule natural rubber is added to the rubber polymer mixture at greater than or equal to about 2 PHR to less than or equal to about 50 PHR. In the rubber industry, parts per hundred rubber (PHR) quantifies the concentration of a particular additive in a rubber mixture (e.g., a mixture having 5 PHR additives would have 5 kilograms additives per every 100 kilograms of rubber polymer). The resulting rubber composite desired can dictate the amount of liquid guayule natural rubber. By way of non-limiting example, tire tread applications may dictate an amount of liquid guayule natural rubber of greater than or equal to about 10 PHR to less than or equal to about 35 PHR. And as a corollary thereto, the composition of the rubber polymer mixture can dictate the amount of liquid guayule natural rubber that should be mixed into the rubber polymer mixture. By way of non-limiting example, when the rubber polymer mixture comprises synthetic rubbers, the amount of liquid guayule natural rubber necessary to adequately mix the rubber mixture in a commercially feasible manner may be greater than or equal to about 2 PHR to less than or equal to about 50 PHR; whereas, when the rubber polymer mixture comprises natural rubbers, the amount of liquid guayule natural rubber necessary to adequately mix rubber mixture in a commercially feasible manner may be greater than or equal to about 2 PHR to less than or equal to about 20 PHR. Liquid guayule natural rubber as a plasticizer offers superior compatibility over conventional plasticizers, such as petroleum crude oil plasticizers. First, rubber composites prepared with liquid guayule natural rubber plasticizers offer improved compatibility with the rubber polymer, resulting in less oil bleeding out of a resultant part. Second, such improved rubber composites offer improved tensile strength, modulus, and tear resistance. Third, such improved rubber composites offer improved treat traction. Finally, such improved rubber composites have higher dynamic and static stiffness.

It is further contemplated that additives may optionally be added to enhance the properties of the rubber composites disclosed herein. Additives include carbon black, silica, stearic acid, sulfur, accelerators, antiozonants, antioxidants, clay, calcium carbonate, coupling aids, activators, and processing aids. The concentration of any particular additives and/or whether any particular additive is required may be dictated by the composition of the rubber polymer mixture and/or the rubber composite desired.

Carbon black may be used as a reinforcing filler. Examples of carbon black include furnace black, acetylene black, thermal black, channel black, graphite and the like. Multiple types of carbon black may be added. Carbon black may be added at greater than or equal to about 10 PHR to less than or equal to about 50 PHR.

Silica may be used as a reinforcing filler. When silica is added, a silane coupling agent, such as those known for use in the rubber industry, may further be added. Silica may be added at greater than or equal to about 10 PHR to less than or equal to about 90 PHR.

Stearic acid can increase the vulcanization rate and increase the productivity of the rubber composite. Stearic acid may be added at less than or equal to about 5 PHR.

Sulfur acts as a vulcanization agent. Sulfur may be added at less than or equal to about 5 PHR.

Activators, like zinc oxide, increase the vulcanization rate and increase the productivity of the rubber compound. Activators may be added at less than or equal to about 10 PHR.

Additional vulcanization accelerators include vulcanizers having sulfonamide, thiazole, thiuram, thiourea, guanidine, dithiocarbamate, aldehyde amine, aldehyde ammonia, imidazoline and xanthate bases. Multiple types of the vulcanization accelerators may be used. Accelerators may be added at less than or equal to about 3 PHR.

Antiozonants are organic compounds that prevent the degradation of the rubber composite caused by ozone. Antiozonants may be added at less than or equal to about 2 PHR.

Antioxidants also inhibit deterioration of the rubber composite. Antioxidants may be added at less than or equal to about 2 PHR.

Clay is an additional reinforcing filler typically used in rubber composites prepared for producing tires. Clay may be added at less than or equal to about 200 PHR.

Calcium carbonate is an additional reinforcing filler typically used in rubber composites prepared for producing tires and floor mats. Calcium carbonate may be added at less than or equal to about 100 PHR. In tire applications, calcium carbonate is more typically added at less than or equal to about 2 PHR.

Processing aids, such as waxes and oil, can assist with lowering the energy required to form the rubber composite by encouraging mixability between the rubber mixture and other additives. Processing aids may be added at less than or equal to about 5 PHR.

The rubber composites according to the present disclosure can be prepared by known methods, such as by kneading the rubber mixture with a rubber kneading machine such as an open roll, a Banbury mixer, or an enclosed kneader, followed by vulcanizing the kneaded product.

It is contemplated the rubber composites disclosed herein can be formed into any typical product formed of rubber composites. Non-limiting examples include vehicle bushings such as automotive motor mounts, sub-frame mounts, alternator bushings, control arm bushings, shock absorber mountings, sway bar links, and transmission shifters; automotive mats; footwear; and automobile tires.

Notably, the rubber composites disclosed herein do not require petroleum crude oil, such as naphthenic oil, as plasticizers. Moreover, the rubber composites disclosed herein achieve superior compatibility with the rubber polymer; improved tensile strength, modulus, and tear resistance; improved tread traction; and higher dynamic and static stiffness than conventional rubber composites having petroleum crude oil plasticizers.

According to another aspect of the present disclosure, liquid hevea natural rubber is used as a plasticizer in a rubber composite. Hevea is a woody plant that can have extracted therefrom useful products such as natural rubber and latex. Hevea natural rubber can be extracted according to known methods, which includes making an incision into a hevea tree, from which sap flows. The latex is refined into rubber for commercial processing.

Producing liquid hevea natural rubber involves heating solid hevea natural rubber to a temperature sufficient to initiate thermal decomposition the solid hevea natural rubber and holding until the temperature is at about the temperature at which thermal decomposition initiates for a time sufficient to melt the solid hevea natural rubber. Alternatively, solid hevea natural rubber may be melted to liquid guayule natural rubber by exposing the solid hevea natural rubber to ultraviolet light for a period of time sufficient to melt the solid hevea natural rubber. In another variation, solid hevea natural rubber may be melted to liquid guayule natural rubber via chemical degradation, such as by immersing small pieces of the solid hevea natural rubber in an acid bath (e.g., periodic acid) for a period of time sufficient to degrade the solid hevea natural rubber.

It is believed melting the hevea natural rubber into liquid hevea natural rubber breaks longer hevea rubber polymer chains into smaller hevea rubber polymer chains, thereby enhancing miscibility with the synthetic or natural rubber polymers forming the resultant rubber composite contemplated herein. As such, it is contemplated that the above-mentioned processes for producing liquid hevea natural rubber from solid hevea rubber or hevea latex are exemplary in nature and other processes that adequately produce liquid hevea natural rubber are within the scope of the present disclosure.

The liquid hevea natural rubber is used as a plasticizer with a mixture of rubber polymers.

Examples of the mixture of rubber polymers include mixtures of synthetic rubber, mixtures of natural rubber, mixtures of various synthetic rubbers, mixtures of various natural rubbers, and mixtures of synthetic and natural rubbers. Examples of synthetic rubbers include but are not limited to SBR, SIR, SIBR, IR, CSM, ECO, fluoroelestomers, fluorocarbons, fluorosilicone rubber, HNBR, acrylonitrile butadiene rubber, FFKM, ACM, BR, EPDM, CR, NBR, and IIR. According to an example, the rubber polymer mixture includes SBR. Examples of natural rubber include GNR and HNR.

Liquid hevea natural rubber is added to the rubber polymer mixture at greater than or equal to about 2 PHR to less than or equal to about 50 PHR. The resulting rubber composite desired can dictate the amount of liquid hevea natural rubber. By way of non-limiting example, tire tread applications may dictate an amount of liquid hevea natural rubber of greater than or equal to about 10 PHR to less than or equal to about 35 PHR. And as a corollary thereto, the composition of the rubber polymer mixture can dictate the amount of liquid hevea natural rubber that should be mixed into the rubber polymer mixture. By way of non-limiting example, when the rubber polymer mixture comprises synthetic rubbers, the amount of liquid hevea natural rubber necessary to adequately mix the rubber mixture in a commercially feasible manner may be greater than or equal to about 2 PHR to less than or equal to about 50 PHR; whereas, when the rubber polymer mixture comprises natural rubbers, the amount of liquid hevea natural rubber necessary to adequately mix rubber mixture in a commercially feasible manner may be greater than or equal to about 2 PHR to less than or equal to about 20 PHR. Liquid hevea natural rubber as a plasticizer offers superior compatibility over conventional plasticizers, such as petroleum crude oil plasticizers. First, rubber composites prepared with liquid hevea natural rubber plasticizers offer improved compatibility with the rubber polymer, resulting in less oil bleeding out of a resultant part. Second, such improved rubber composites offer improved tensile strength, modulus, and tear resistance. Third, such improved rubber composites offer improved treat traction. Finally, such improved rubber composites have higher dynamic and static stiffness.

It is further contemplated that additives may optionally be added to enhance the properties of the rubber composites disclosed herein. Additives include carbon black, silica, stearic acid, sulfur, accelerators, antiozonants, antioxidants, clay, calcium carbonate, coupling aids, activators, and processing aids. The concentration of any particular additives and/or whether any particular additive is required may be dictated by the composition of the rubber polymer mixture and/or the rubber composite desired.

Carbon black may be used as a reinforcing filler. Examples of carbon black include furnace black, acetylene black, thermal black, channel black, graphite and the like. Multiple types of carbon black may be added. Carbon black may be added at greater than or equal to about 10 PHR to less than or equal to about 50 PHR.

Silica may be used as a reinforcing filler. When silica is added, a silane coupling agent, such as those known for use in the rubber industry, may further be added. Silica may be added at greater than or equal to about 10 PHR to less than or equal to about 90 PHR.

Stearic acid can increase the vulcanization rate and increase the productivity of the rubber composite. Stearic acid may be added at less than or equal to about 5 PHR.

Sulfur acts as a vulcanization agent. Sulfur may be added at less than or equal to about 5 PHR.

Activators, like zinc oxide, increase the vulcanization rate and increase the productivity of the rubber composite. Activators may be added at less than or equal to about 10 PHR.

Additional vulcanization accelerators include vulcanizers having sulfonamide, thiazole, thiuram, thiourea, guanidine, dithiocarbamate, aldehyde amine, aldehyde ammonia, imidazoline and xanthate bases. Multiple types of the vulcanization accelerators may be used. Accelerators may be added at less than or equal to about 3 PHR.

Antiozonants are organic compounds that prevent the degradation of the rubber composite caused by ozone. Antiozonants may be added at less than or equal to about 2 PHR.

Antioxidants also inhibit deterioration of the rubber composite. Antioxidants may be added at less than or equal to about 2 PHR.

Clay is an additional reinforcing filler typically used in rubber composites prepared for producing tires. Clay may be added at less than or equal to about 200 PHR.

Calcium carbonate is an additional reinforcing filler typically used in rubber composites prepared for producing tires and floor mats. Calcium carbonate may be added at less than or equal to about 100 PHR. In tire applications, calcium carbonate is more typically added at less than or equal to about 2 PHR.

Processing aids, such as waxes, can assist with lowering the energy required to form the rubber composite by encouraging mixability between the rubber mixture and other additives. Processing aids may be added at less than or equal to about 5 PHR.

The rubber composites according to the present disclosure can be prepared by known methods, such as by kneading the rubber mixture with a rubber kneading machine such as an open roll, a Banbury mixer, or an enclosed kneader, followed by vulcanizing the kneaded product.

It is contemplated the rubber composites disclosed herein can be formed into any typical product formed of rubber composites. Non-limiting examples include vehicle bushings such as automotive motor mounts, sub-frame mounts, alternator bushings, control arm bushings, shock absorber mountings, sway bar links, and transmission shifters; automotive mats; footwear; and automobile tires.

Notably, the rubber composites disclosed herein do not require petroleum crude oil, such as naphthenic oil, as plasticizers. Moreover, the rubber composites disclosed herein achieve superior compatibility with the rubber polymer; improved tensile strength, modulus, and tear resistance; improved tread traction; and higher dynamic and static stiffness than conventional rubber composites having petroleum crude oil plasticizers.

### Examples and Comparative Examples

The present disclosure is described based on examples, but the present disclosure should not be limited thereto.

Three examples and dix comparative examples were prepared. A variety of synthetic rubber polymers, natural rubber polymers, plasticizers, and additives used in the examples are explained below.

SBR: styrene-butadiene rubber.

HNR: hevea natural rubber.

GNR: guayule natural rubber.

LGNR: liquid guayule natural rubber plasticizer.

Corsol 2400: Naphthenic oil (NO) plasticizer commercially available from R.E. Carroll, Inc.

Carbon black: additive.

Sulfur: additive.

Zinc oxide: additive.

TBBS accelerator: N-tert-butyl-benzothiazole sulfonamide additive commercially available from Western Reserve Chemical.

Stearic acid: additive.

6PPD: N-(1,3-Dimethylbutyl)-N′-phenyl-p-phenylenediamine antiozonant and antioxidant additive commercially available from Eastman Chemical Company.

TABLE 1

| | Examples | | | Comparative Examples | | | | | |
|---|---|---|---|---|---|---|---|---|---|
| | 1 | 2 | 3 | 1 | 2 | 3 | 4 | 5 | 6 |
| SBR | 100 | 0 | 0 | 100 | 0 | 0 | 100 | 0 | 0 |
| HNR | 0 | 100 | 0 | 0 | 100 | 0 | 0 | 100 | 0 |
| GNR | 0 | 0 | 100 | 0 | 0 | 100 | 0 | 0 | 100 |
| Corsol | 0 | 0 | 0 | 20 | 20 | 20 | 0 | 0 | 0 |
| 2400 | | | | | | | | | |
| LGNR | 20 | 20 | 20 | 0 | 0 | 0 | 0 | 0 | 0 |
| Carbon | 50 | 50 | 50 | 50 | 50 | 50 | 50 | 50 | 50 |
| Black | | | | | | | | | |
| Sulfur | 4.5 | 4.5 | 4.5 | 4.5 | 4.5 | 4.5 | 4.5 | 4.5 | 4.5 |
| Zinc | 5 | 5 | 5 | 5 | 5 | 5 | 5 | 5 | 5 |
| oxide | | | | | | | | | |
| TBBS | 1 | 1 | 1 | 1 | 1 | 1 | 1 | 1 | 1 |
| Stearic | 1 | 1 | 1 | 1 | 1 | 1 | 1 | 1 | 1 |
| acid | | | | | | | | | |
| 6PPD | 2 | 2 | 2 | 2 | 2 | 2 | 2 | 2 | 2 |

TABLE 2

| | Examples | | | Comparative Examples | | | | | |
|---|---|---|---|---|---|---|---|---|---|
| | 1 | 2 | 3 | 1 | 2 | 3 | 4 | 5 | 6 |
| Tensile | 21.1 | 28.6 | 25.9 | 17.9 | 26.7 | 22.3 | 20.5 | 27.4 | 22.9 |
| strength | | | | | | | | | |
| Elongation | 248.9 | 411.0 | 424.5 | 239.6 | 376.6 | 389.7 | 156.9 | 308.1 | 301.0 |
| at break | | | | | | | | | |
| Modulus | 6.5 | 4.8 | 4.4 | 5.6 | 4.5 | 4.1 | 11.5 | 6.7 | 6.5 |
| at 100% | | | | | | | | | |
| strain | | | | | | | | | |
| Hardness | 69.8 | 67.8 | 66.0 | 67.2 | 64.2 | 63.0 | 77.6 | 72.6 | 74.2 |
| Number | | | | | | | | | |

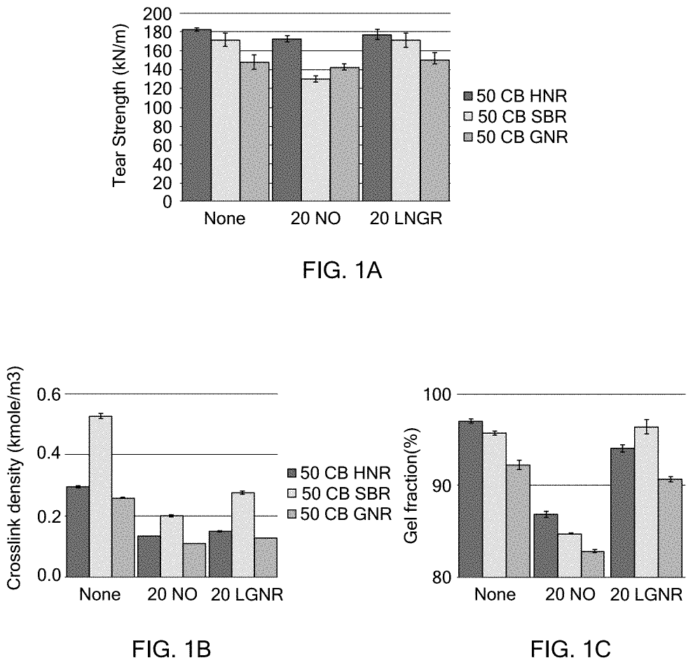

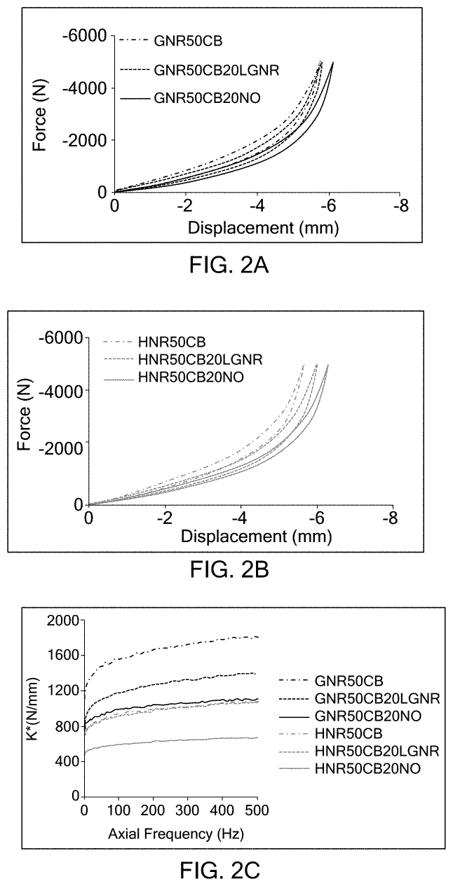

Fillers and compounding ingredients were incorporated into the rubber using a Farrel Model BR Banbury mixer at a 70% fill factor, a temperature set point of 150° C., ram pressure of 0.34 MPa, and rotor speed set at 6.3 rad/s. After mixing, the compound was passed through a Farrel two-roll mill. Curing behavior was analyzed according to ASTM D2084 using a Monsanto Rheometer ODR 2000. Composites were cured as sheets with a thickness of 2 mm at 160° C., with 15 tons of force and curing time equal to t₉₀+5 minutes. After curing, the materials were conditioned at room temperature for 24 hours before testing. The following evaluations were made using the obtained vulcanized example rubber polymer composites and the vulcanized comparative example rubber composites. The results of the evaluations are shown in Table 2, FIG. 1, and FIG. 2.

### Tensile Properties

The tensile strength of each of the examples and comparative examples were measured along the grain direction according to ASTM D412 Test Method A, Die C, using an Instron dual column testing system equipped with a 5-kN load cell and a long-travel extensometer with a crosshead speed of 500 mm/min and gage length of 25 mm. As expected, the comparative examples that used NO plasticizers had lower tensile strength than the comparative examples with no plasticizers, as plasticizers weaken the rubber-rubber interactions in the rubber network. But the examples using LNGR as a plasticizer resulted in plastic composites having higher tensile strengths than rubber composites having no plasticizer. This increase of tensile strength is due to the covalent bonds which form between LGRN and rubber polymers.

Elongation at break of each of the examples and comparative examples were measured along the grain direction according to ASTM D412 Test Method A, Die C, using an Instron dual column testing system equipped with a 5-kN load cell and a long-travel extensometer with a crosshead speed of 500 mm/min and gage length of 25 mm. Elongation at break was increased when using the plasticizers NO and LGNR because the plasticizing effect in which the plasticizers aids creates a degree of separation from the rubber polymers. The examples having LGNR plasticizers stretched farther before breaking than the comparative examples having NO plasticizers because of their higher strength. This is believed to be due to the LGNR covalent interaction with the rubber polymers.

Modulus at 100% strain of each of the examples and comparative examples were measured along the grain direction according to ASTM D412 Test Method A, Die C, using an Instron dual column testing system equipped with a 5-kN load cell and a long-travel extensometer with a crosshead speed of 500 mm/min and gage length of 25 mm. The plasticizing effect softened the cured rubber composites. The softening of the examples having LGNR plasticizers, however, was markedly decreased as opposed to the softening of the comparative examples having NO plasticizers. This is believed to be due to the LGNR covalent interaction with the rubber polymers.

Hardness of each of the examples and the comparative examples were measured according to ASTM 2240 using a Shore A durometer. The examples and comparative examples having plasticizers exhibited less hardness than the comparative examples that had no plasticizers. The decrease in hardness of the examples having LGNR plasticizers, however, was markedly decreased as opposed to the decrease in hardness of the comparative examples having NO plasticizers. The LGNR covalent interaction with the rubber polymers may account for the greater retention of hardness as opposed to the comparative examples having NO.

### Tear Resistance and Crosslink Density

Tear strength of each of the examples and the comparative examples were measured along the grain direction according to ASTM D624, Die B, using an Instron dual column testing system equipped with a 5-kN load cell and a long-travel extensometer with a crosshead speed of 500 mm/min and gage length of 25. As shown in FIG. 1, the examples where LGNR filled SBR had greater tear strength than the comparative example having NO filled SBR or the comparative example having SBR without plasticizer. The examples where LGNR filled HNR and GNR changed little compared to the comparative examples of HNR and GNR without plasticizers. The comparative examples where NO filled SBR and GNR exhibited a marked decrease compared to the comparative examples of SBR and GNR without plasticizers.

Crosslink density of each of the examples and the comparative examples were by weighing dried samples of 10 mm×10 mm×2 mm of the examples and the comparative examples and recording the weight to an accuracy of 1 mg. The dried samples were then immersed in toluene at 25° C. for 96 hours, with the solvent being replaced by fresh solvent every 24 hours during the swelling period, in accord with ASTM D6814. Excess solvent was decanted, and the samples were blotted and weighed. The swollen samples were fully dried at 100° C. for 24 hours and reweighed. The crosslink density was calculated by the Flory-Rehner equation:

$$- ln ( 1 - {V}_{r} ) - {V}_{r} - χ {V}_{r}^{2} = {V}_{s} {η}_{swell} ( {V}_{r}^{\frac{1}{3}} - \frac{{V}_{r}}{2} ) \qquad ( 1 )$$

Where χ is the polymer-solvent interaction parameter, Vᵣ is the volume fraction of the rubber in swollen gel. For HNR-toluene and GNR-toluene, χ is 0.391, and the χ of SBR-toluene is 0.31. η_{swell} is the crosslink density of rubber (kmol/m³). Vₛ is the molar volume of toluene (106.27 cm³/mol). The volume fraction, Vr, was calculated using the following equation:

$${V}_{r} = \frac{{V}_{rubber}}{{V}_{solvent} + {V}_{rubber}} = ( \frac{{m}_{d} - {m}_{b} \times f}{{ρ}_{rubber}} ) \div [ \frac{{m}_{s} - {m}_{d}}{{ρ}_{solvent}} + ( \frac{{m}_{d} - {m}_{b} \times f}{{ρ}_{rubber}} ) ] \qquad ( 2 )$$

In equation (2), m_{b}, mₛ, m_{d} are the weights of the sample: m_{b} is before swelling, mₛ is swollen weight and m_{d} is dry weight measured after drying the swollen samples. ρ_{rubber} and ρₛₒₗᵥₑₙₜ are the density of rubber matrix (HNR, SBR and GNR) and toluene. ρ_{rubber} of HNR, SBR and GNR were respectively 0.91, 0.85 and 0.92 g/cm³, which were measured by an analytical balance (Model ME54E, Mettler Toledo, Columbus, Ohio), ρₛₒₗᵥₑₙₜ was 0.867 g/cm³ and f is the weight fraction of non-rubber components.

As shown in FIG. 1, the examples and comparative examples having plasticizers exhibited less crosslink density than the comparative examples that had no plasticizers. The decrease in crosslink density of the examples having LGNR plasticizers, however, was markedly decreased as opposed to the decrease in crosslink density of the comparative examples having NO plasticizers, suggesting a stronger LGNR-rubber polymer interaction than in rubber composites produced with NO plasticizers. Moreover, this interaction was especially pronounced with the examples comprised of LGNR filled SBR.

Gel fraction of each of the examples and the comparative examples were calculated by the weight of the dried sample (m_{d}) divided by the initial weight (m_{b}) as shown in Equation 2, above. As shown in FIG. 1, the examples and comparative examples having plasticizers exhibited reduced gel fraction than the comparative examples that had no plasticizers. The reduction in gel fraction of the examples having LGNR plasticizers, however, was markedly decreased as opposed to the reduction in gel fraction of the comparative examples having NO plasticizers. This shows the strong LGNR-rubber polymer network prevented solvent extraction of free rubber polymer. Contrariwise, the low gel fraction of the comparative examples having NO plasticizers shows that NO increases the separation between rubber molecules and that more rubber polymers remain soluble.

### Static and Dynamic Stiffness

Static and dynamic stiffness of each of the examples and the comparative examples were determined. First, static stiffness of the composites was determined using an MTS 831 Servo hydraulic machine according to ASTM D575. Cylindrical shaped specimens (28.6±0.1 mm in diameter and 12.5±0.5 mm in height) were compressed 12±3 mm/min until a preset force was reached. Compressive force was applied for three successive cycles in order to reduce Mullins effect. Deflection achieved with a given load was measured in the third cycle. Preloads for dynamic testing were selected thereafter and were based on the load deflection behavior of the tested composites, such as which offered the largest static load and/or whether any of the displacement the material could withstand during static testing revealed a linear response to the load applied. In the instant tests, frequency sweeps from 0 to 500 Hz at an amplitude of 0.01 mm peak to peak, and 0 to 120 Hz at 0.316 mm peak to peak were performed using a 500 N pre-load in both frequency sweeps. Temperature was held at room temperature and humidity was controlled during testing. As shown in FIG. 2, the examples having LGNR plasticizers exhibit similar static and dynamic stiffness as compared to the comparative examples having NO plasticizers. Rubber composites having NO plasticizers exhibit lower dynamic and static stiffness than rubber composites having no plasticizers and rubber composites having LGNR plasticizers.

From the results in the examples and comparative examples, it is seen that the rubber composites according to the present disclosure exhibit better tensile properties, tear resistance, crosslink density, and static and dynamic stiffness than conventional composites using petroleum crude oil.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A rubber composite material having a rubber polymer comprising at least one of a natural and a synthetic rubber polymer and a guayule natural rubber plasticizer added as a liquid during processing.

2. The rubber composite material according to claim 1, wherein the rubber composite material is substantially free of petroleum crude oil.

3. The rubber composite material according to claim 1, further comprising an additive.

4. The rubber composite material according to claim 3, wherein at the additive is carbon black.

5. The rubber composite material according to claim 1, wherein the rubber composite material forms a bushing for a vehicle.

6. The rubber composite material according to claim 1, wherein the rubber polymer comprises a natural rubber polymer.

7. The rubber composite material according to claim 1, wherein the rubber polymer comprises styrene-butadiene rubber polymer.

8. A rubber composite material having a rubber polymer comprising at least one of a natural and a synthetic rubber polymer and a plasticizer comprising at least one of a liquid guayule natural rubber and a liquid hevea natural rubber plasticizer added as a liquid during processing, wherein the rubber composite material is substantially free of petroleum crude oil.

9. The rubber composite material according to claim 8, wherein the plasticizer is liquid guayule natural rubber.

10. The rubber composite material according to claim 8, further comprising an additive.

11. The rubber composite material according to claim 10, wherein the additive is carbon black.

12. The rubber composite material according to claim 8, wherein the rubber composite material forms at least a portion of a bushing for a vehicle.

13. The rubber composite material according to claim 8, wherein the rubber polymer comprises a natural rubber polymer.

14. The rubber composite material according to claim 8, wherein the rubber polymer comprises styrene-butadiene rubber polymer.

15. A method of making a rubber composite material, the method comprising:
liquefying at least one of a guayule solid natural rubber and a guayule latex to form a liquid guayule natural rubber;
mixing the liquid guayule natural rubber with at least one of a natural and a synthetic rubber polymer to form a rubber mixture; and
vulcanizing the rubber mixture.

16. The method according to claim 15, wherein the mixing includes mixing an additive.

17. The method according to claim 16, wherein the additive is carbon black.

18. The method according to claim 15, further comprising forming the rubber mixture into a bushing.

19. The method according to claim 15, wherein the at least one of a natural and a synthetic rubber polymer is a natural rubber polymer.

20. The method according to claim 15, wherein the at least one of a natural and a synthetic rubber polymer is styrene-butadiene rubber polymer.
